(19) United States
(12) Patent Application Publication
(10) Pub. No.: US 2014/0153448 A1
(43) Pub. Date: Jun. 5, 2014

(54) Interference Management for Time Division Duplex Operation

(71) Applicant: NOKIA CORPORATION, Espoo (FI)

(72) Inventors: Cássio B. RIBEIRO, Espoo (FI); Michal CIERNY, Helsinki (FI)

(73) Assignee: NOKIA CORPORATION, Espoo (FI)

(21) Appl. No.: 13/691,078

(22) Filed: Nov. 30, 2012

(51) Int. Cl. H04L 5/14; H04B 15/00

(52) U.S. Cl. CPC H04L 5/14; H04B 15/00
USPC 370/280

(57) ABSTRACT

Communication systems may benefit from various interference management procedures. For example, uncoordinated time division duplex systems may benefit from flexible time division duplex operation that includes an interference management procedure that may be applicable to various carriers. A method may include determining a way in which a subframe in a frame structure will be used within a predetermined or undetermined amount of time. The method may also include communicating the way the subframe will be used to an affected device.

### BACKGROUND

1. Field

Communication systems may benefit from various interference management procedures. For example, uncoordinated time division duplex systems may benefit from flexible time division duplex operation that includes an interference management procedure that may be applicable to various carriers.

2. Description of the Related Art

In small cells, distances between base station (BS) and user equipment (UE) are typically small. Thus, due to uplink (UL) power control, user equipment transmission power in uplink may also be relatively small, and may be much smaller than base station transmission power in downlink (DL).

With flexible time division duplex (TDD) it is possible that a subframe that was previously configured as uplink is reconfigured as downlink. This means that weak interference in a specific flexible subframe within a radio frame may change to strong interference with, for example, time scale of one radio frame. This can even happen when the victim cell is having uplink transmission in the given subframe.

FIG. 1 illustrates various interference situations between two neighboring small cells. As shown in FIG. 1, BS 1 may be a victim base station in uplink mode. In case 110, BS 2 is also in uplink mode and due to uplink power control interference to BS 1 is smaller. In case 120, BS 2 is in downlink mode and interference to BS 1 is therefore stronger than in case 110.

Tight coordination among cells, including, for example, UL and DL configurations, may not always be possible, for a variety of reasons. For example, base stations (BSs) may lack a centralized controller. Moreover, the base stations may lack a standardized BS-to-BS interface, such as the X2 interface. One alternative to such coordination may be a set of rules, such as a procedure that would serve as way to accomplish distributed flexible time division duplex (TDD) interference management.

When a victim base station is in uplink mode, the use of flexible physical layer, for example as a new carrier type (NCT) in third generation partnership project (3GPP) Long Term Evolution (LTE), may offer some level of interference avoidance access. The physical uplink control channel (PUCCH) may be located at the edges of the uplink band. Therefore, an aggressor base station can place its band-limited downlink transmission in a more central part of the band. In that way, a physical uplink shared channel (PUSCH) of the victim base station could be compromised still, but the PUCCH at the edges of the band would not.

FIG. 2 illustrates limited interference avoidance option in new carrier type. Cell 1 operates in uplink and receives PUCCH at the band edges and PUSCH/PUCCH from different UEs in between. In cell 2 the BS therefore places its downlink transmission to the central part. This still collides with PUSCH/PUCCH of UE 2 and UE 3 in cell 1, but some UE transmissions and especially PUCCH at the band edges are not compromised.

However, by applying such approach the victim base station may not learn any future intentions of the aggressor base station, such as whether the aggressor base station plans to use less or more of the bandwidth in a next frame. Moreover, the victim base station may completely fail when the aggressor base station needs to use the whole bandwidth.

### SUMMARY

According to certain embodiments, a method includes determining a way in which a subframe in a frame structure will be used within a determined or undetermined amount of time. The method also includes communicating the way the subframe will be used to an affected device.

In certain embodiments, a method includes identifying a way in which a subframe in a frame structure will be used within a predetermined or undetermined amount of time. The method also includes adapting a radio resource usage based on the way the frame structure will be used.

An apparatus, according to certain embodiments, includes at least one processor and at least one memory including computer program code. The at least one memory and the computer program code are configured to, with the at least one processor, cause the apparatus at least to determine a way in which a subframe in a frame structure will be used within a predetermined or undetermined amount of time. The at least one memory and the computer program code are also configured to, with the at least one processor, cause the apparatus at least to communicate the way the subframe will be used to an affected device.

An apparatus, in certain embodiments, includes at least one processor and at least one memory including computer program code. The at least one memory and the computer program code are configured to, with the at least one processor, cause the apparatus at least to identify a way in which a subframe in a frame structure will be used within a predetermined or undetermined amount of time. The at least one memory and the computer program code are also configured to, with the at least one processor, cause the apparatus at least to adapt a radio resource usage based on the way the frame structure will be used.

According to certain embodiments, an apparatus includes determining means for determining a way in which a subframe in a frame structure will be used within a predetermined or undetermined amount of time. The apparatus also includes communicating means for communicating the way the subframe will be used to an affected device.

In certain embodiments, an apparatus includes identifying means for identifying a way in which a subframe in a frame structure will be used within a predetermined or undetermined amount of time. The apparatus also includes adapting means for adapting a radio resource usage based on the way the frame structure will be used.

A non-transitory computer-readable medium is, in certain embodiments, encoded with instructions that, when executed in hardware, perform a process. The process includes determining a way in which a subframe in a frame structure will be used within a predetermined or undetermined amount of time. The process also includes communicating the way the subframe will be used to an affected device.

A non-transitory computer-readable medium is, according to certain embodiments, encoded with instructions that, when executed in hardware, perform a process. The process includes identifying a way in which a subframe in a frame structure will be used within a predetermined or undetermined amount of time. The process also includes adapting a radio resource usage based on the way the frame structure will be used.

### BRIEF DESCRIPTION OF THE DRAWINGS

For proper understanding of the invention, reference should be made to the accompanying drawings, wherein:

FIG. 1 illustrates various interference situations between two neighboring small cells.

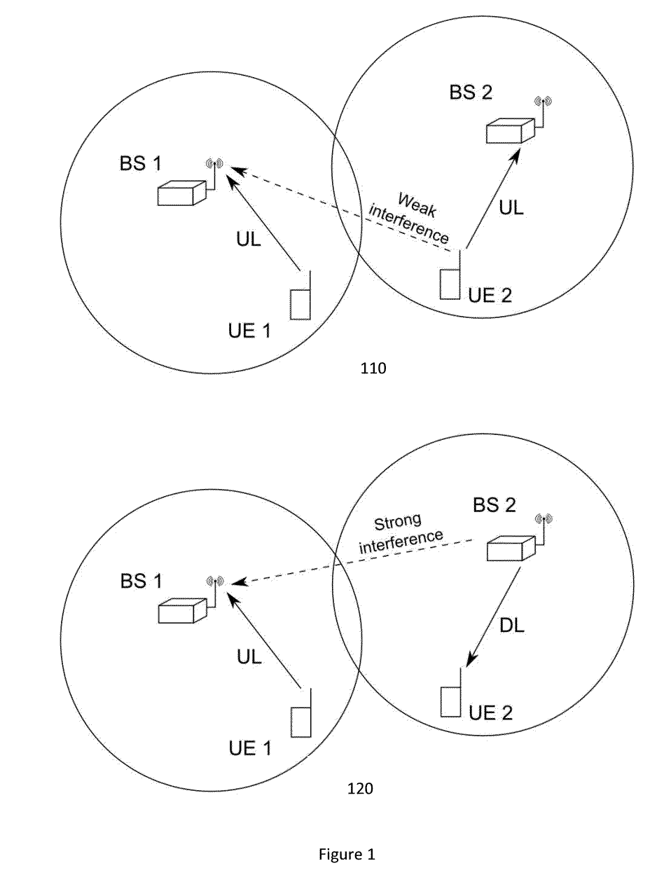

FIG. 2 illustrates limited interference avoidance option in new carrier type.

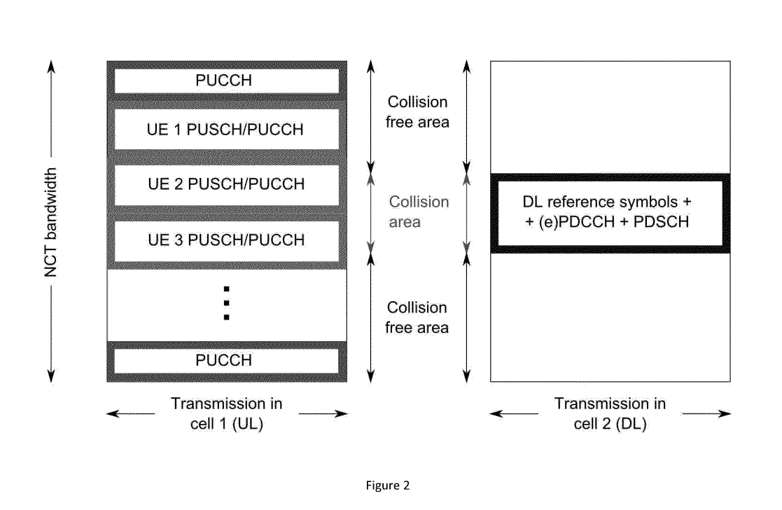

FIG. 3 illustrates three sample frame structures.

FIG. 4 illustrates four examples of transmission intentions messages according to certain embodiments.

FIG. 5 illustrates a method according to certain embodiments.

FIG. 6 illustrates another method according to certain embodiments.

FIG. 7 illustrates a system according to certain embodiments.

### DETAILED DESCRIPTION

In order for a victim base station (BS) to maintain its transmission quality, it may be useful to have information about an incoming increase or decrease in interference power in advance.

Certain embodiments deal with interference management/coordination for flexible time division duplex (TDD) operation of small cells within a cellular wireless system. Small cells can include, for example, femtocells or picocells, as well as any cells served by base stations with limited power compared to conventional macro base stations. Thus, small cells broadly can include cells other than femtocells or picocells. Such cells may cover much smaller area than macrocells and may serve smaller number of users than macrocells on a per access point or base station basis, although on a per unit area basis small cells may serve a higher density of users. Some of the small base stations (BSs) in such small cells may, for example, be deployed by users as plug-and-play devices. Hence, these devices may not be easily taken into account in frequency/site planning. Even when such cells are deployed by a network operator, they may not have been part of the initial site planning and it may be cumbersome for the network operator to update the network planning after the addition of extra small cells. Also, some of the small base stations may lack a base station to base station (BS-to-BS) interface, such as the X2 interface in 3GPP, as mentioned above. Thus, these small base stations may be unable to coordinate their actions either with the network in general or with other small base stations.

Flexible time division duplex can include a mode of operation in which the base station can adapt its frame structure according to, for example, dynamics of data traffic in the cell under its coverage. The frame structure can refer to the configuration of uplink (UL) and downlink (DL) subframes. Flexible time division duplex may provide better performance than static time division duplex, particularly in cells that have relatively small number of active user equipments (UEs). Given that small cells are typically serving a low number of UEs, flexible time division duplex may be suitable for this type of scenario.

In 3GPP LTE a new carrier type (NCT) is being defined that may include features such as reduction of cell-specific reference signals (CRS) in time and/or frequency domain, including the possibility of completely empty subframes, and long evolved Node B (eNB) discontinuous transmission (DTX) cycles. By contrast, in a normal carrier CRS may have to be present in the whole transmission band, whether there is a data transmission present or not. In NCT, there may be a possibility to reduce the CRS presence to a smaller portion of the band, for example, six resource blocks (RBs) as minimum, or possibly no CRS at all.

A distributed interference management mechanism for flexible time division duplex according to certain embodiments can include various features of a transmission procedure. For example, a base station that will reconfigure a given flexible subframe from uplink to downlink can indicate the base station's intentions in a way that a victim base station can adapt the victim base station's own transmission in order to avoid destructive interference.

In another example, signals for indication of intentions in flexible subframe can be defined that may be based, for example on signals existing in current 3GPP LTE specifications. The intentions in flexible subframe can be indicated by a presence/absence of a signal, combination of sequences, or explicitly by encoding control bits into the signal itself, or any other signal.

Thus, in certain embodiments, the base station that reconfigures the flexible subframe direction from uplink to downlink may not merely provide a warning, but may provide more detailed intentions of the bandwidth use in future frames.

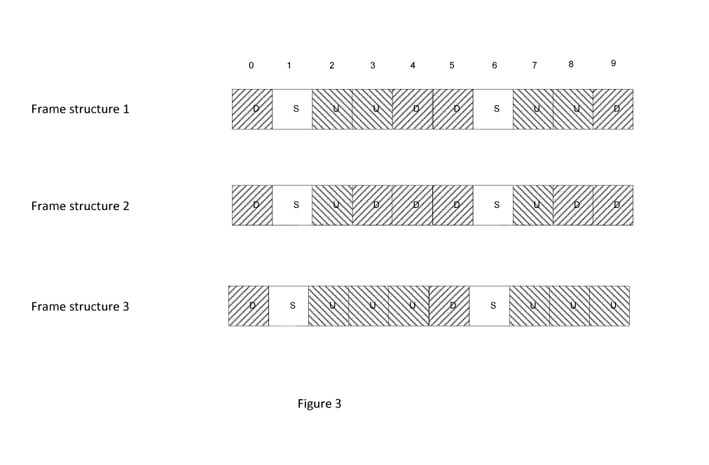

A cellular wireless system in time division duplex mode can have several frame structures to choose from. FIG. 3 illustrates three sample frame structures, although other frame structures are possible and permitted.

In FIG. 3, DL stands for downlink subframe, UL stands for uplink subframe, and S stands for special subframe. Special subframes are not being discussed in as great detail, but may be handled analogously to the way that UL and DL are handled, if desired.

As shown in FIG. 3, frame structure 1 has equal number of downlink and uplink subframes, frame structure 2 has more downlink subframes, and frame structure 3 has more uplink subframes. Thus, subframes 0, 1, and 2 are always the same in all base stations and there is no cross-direction interference present in them, as well as for subframes 5, 6, and 7. In this case, subframes 3, 4, 7, and 8 can be seen as flexible subframes, because by setting the corresponding frame structure a base station can adapt the base station's transmission order according to traffic characteristics.

To be more specific, a base station with balanced uplink and downlink traffic and/or a higher number of connected user equipment devices may choose frame structure 1. On the other hand, a base station with noticeably more downlink traffic than uplink traffic may benefit from frame structure 2. Likewise, a base station with noticeably more uplink traffic can benefit from frame structure 3.

When a base station changes direction of some flexible subframe from uplink to downlink, for example, changes the frame structure from 1 to 2, or from 3 to 1 or 2, a neighbor victim cell may see a noticeable increase in the level of interference in certain subframe(s). This may especially be problematic if the victim cell is a small cell in uplink, because uplink transmission power in a small cell may be low, due to a short distance between base station and user equipment.

To counteract the sudden increase in inter-cell interference, or for other purposes, in certain embodiments an aggressor flexible time division duplex cell can transmit the cell's intentions for the flexible subframe in an over-the-air manner before or during a first downlink transmission in a given subframe. Such a message may allow the victim cell to organize its transmission in a manner that does not endanger the quality of service of the users of the victim cell. These messages may be referred to as transmission intentions (TI) messages.

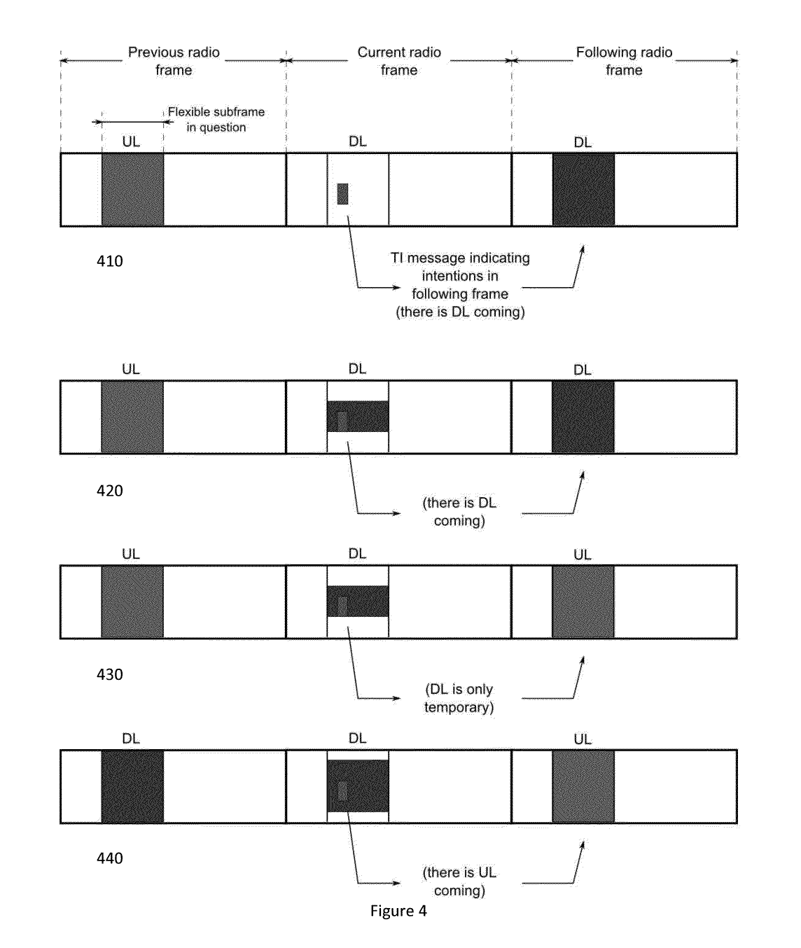

FIG. 4 illustrates four examples of transmission intentions messages according to certain embodiments. In FIG. 4, radio frame is used as a basis for time structure, although other repetitive logical elements, such as a set of subframes within a frame, can serve the same purpose.

Thus, FIG. 4 can illustrate placement and purpose of a TI message. In a given flexible subframe of a current radio frame the aggressor base station can place a TI message that indicates its intentions in the same subframe of a following radio frame, particularly the radio frame immediately following the subframe that contains the indication. A potential victim base station can detect this message and adapt its schedule to counteract the interference.

As illustrated at 410, the aggressor may place a TI message, informing about coming downlink direction, and no data in a current frame, which may minimize potential interference. In this case, the warning is an advance warning of future interference.

As illustrated at 420, the aggressor may place a TI message and some data in a current frame. In this case, the warning is a warning about continuing interference.

As illustrated at 430, the aggressor may place a TI message saying that the downlink direction is only temporary. In this case, the warning is a warning that the interference situation may be similar to the one experienced before the change of subframe to DL direction.

As illustrated at 440, the TI message may specifically say that there will be uplink in following frame. Thus, in this case, the warning is a warning that the interference will be weaker. Therefore, a potential victim cell can use the resources with, for example, higher order modulation.

Other warnings are also possible. For example, an indication can be provided that a future subframe will be a special subframe, or that a future subframe will have no or minimal usage (regardless of classification as uplink or downlink), or information on the maximum bandwidth utilization of the subframe can be provided (regardless of classification as uplink or downlink). The above indications are merely provided as examples. Content of possible TI messages and the signaling possibilities can be variously implemented.

Considering a flexible time division duplex interference management procedure, various messages are possible. For example, when the aggressor base station changes its frame structure such that a flexible subframe changes from uplink to downlink, a “friendly” behavior in the first changed frame may be to use the affected flexible subframe only to transmit the TI message, so that the change does not negatively impact victim cell's transmission and the victim cell can react in the next frame, as illustrated at 410 in FIG. 4. However, this may not always be possible, because flexible time division duplex may take advantage of dynamics in UL/DL traffic, and losing one frame may be impractical.

As a compromise, the aggressor base station may use only a part of the flexible subframe bandwidth and include the TI message within the transmission, as shown at 420 in FIG. 4. The band edges may be avoided as the location for the TI message, so that the message does not collide with PUCCH. In a worst case, the aggressor base station may be required to use the whole available band, which may hinder the victim cell's transmission, but the TI message will at least give enough information for the victim cell to properly prepare itself for the next frame.

The logical TI messages can be, for example, of following types. According to a first type, message type 1, the message can indicate that there will be more downlink transmissions in that specific subframe within the frame structure. This message can indicate that in a following radio frame the aggressor downlink transmission will occupy more resources than in a current frame. A simple form of the message can be a presence/absence or indicator signal. A more elaborate form can indicate details about the resource use that is to occur in the following radio frame. This message type can be used in cases 410 and 420 in FIG. 4. If a victim cell detects this type of message, the victim cell can react by scheduling in different parts of the bandwidth, or by withdrawing from a given flexible subframe.

According to a second type, message type 2, the message can indicate that there will be less downlink transmission in that specific subframe within the frame structure. This message can indicate that the aggressor will be using fewer resources for downlink transmission in the following radio frame. A special version of this message type can be “there will be no downlink transmission” indicating that there is no more downlink data, or that the flexible subframe is changing to uplink. As with the type 1 message, the type 2 message can be a presence/absence of indicator signal or a more elaborate message carrying details about the resource usage. Upon decoding this type of message, the victim cell can use more resources in following frame, or switch to more efficient transmission, for example, a higher modulation and coding scheme (MCS) class. This message type may be used in cases 430 and 440 in FIG. 4.

Various signaling possibilities exist with respect to TI messages. The TI messages can be detected and possibly decoded by an uplink receiver, although other possibilities exist. Three options are discussed below as examples of the numerous ways in which TI messages can be signaled.

According to a first option, signaling option 1, a signal based on sequences that have good cross-correlation properties or that are orthogonal to each other can be used to signal the TI message, for example using similar structure as primary synchronization signals/secondary synchronization signals (PSS/SSS) in 3GPP LTE.

The TI message information can be carried by such signal either implicitly or explicitly. An implicit approach can rely on the presence/absence of a signal. Alternatively, an implicit approach can take advantage of different root sequences or cyclic shifts of the sequences and map the TI message types into a combination of those. An explicit approach can involve encoding TI message bits together with the aforementioned sequences.

According to a second option, signaling option 2, signals with similar structure to uplink reference signals (UL RS) can be used to convey the TI messages. The aggressor base station can transmit such signal structures that carry the TI message. Encoding can be similar as in previous case, and can be either implicit or explicit.

According to a third option, signaling option 3, a signal with similar structure to random access channel (RACH) preamble can be used to indicate the TI message. Encoding can be similar as in previous case, and can be either implicit or explicit.

There may also be an option to provide an entirely new type of signaling. This new type of signaling may take any form as desired in the system.

For any signaling scheme described above, in case of sharing resources between the TI message and physical downlink shared channel (PDSCH), there may be impact on rate matching. Such rate matching can be indicated in a corresponding downlink control information (DCI) message in (e)PDCCH or known to UEs to be present in this type of transition subframe. In any case the base station can apply scheduling restrictions on resources that are used by the TI message.

Because TI messages are transmitted by base stations, there may be no strict time alignment with the ongoing UL transmissions in the victim cell. However, the search space for potential timing errors may be small, since the use of these messages may be more relevant in cases of small cells that are located close to each other. Moreover, a base station may know the approximate timing of reception of signals from neighboring cells due to earlier measurements. Thus, a base station may be able to further reduce the search space.

Certain embodiments have been described with respect to new carrier type (NCT), because NCT may allow band-limited CRS in downlink transmission. Although this may assist an interference management scheme, the approach of sending TI messages one frame ahead of the transmission is not limited by this requirement and can be applied outside of NCT.

Protection of victim uplink transmission is not the only result of procedures with TI messages according to certain embodiments. One other example can be found in device-to-device communication. When an aggressor cell indicates that it will have less downlink transmission, a cell that decodes the TI message can learn that there will be space to facilitate a D2D transmission.

Other variants of the procedures described herein are also possible. For example, one can define a ramping-up of the amount of downlink resources that can be taken by a base station when reconfiguring a subframe from uplink to downlink. This could be used to allow neighboring cells to finish retransmissions and reconfigure their frame structures, if needed.

Even though the description herein considers the case of an uplink subframe being reconfigured into a downlink subframe, certain embodiments also apply when the eNB is leaving a discontinuous transmission (DTX) state. In this case, the eNB may not immediately start with full-blown downlink transmission, but may start using the procedure described herein.

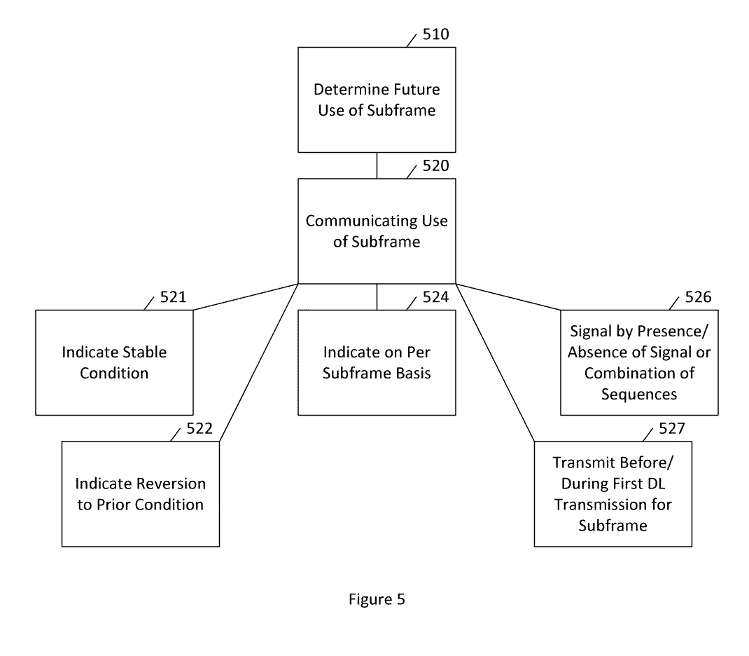

FIG. 5 illustrates a method according to certain embodiments. As shown in FIG. 5, the method may include, at 510, determining a way in which a subframe in a frame structure will be used within a predetermined or undetermined amount of time. The way in which the frame structure will be used may be a change or lack of change in usage. The predetermined amount of time may be the next frame or set of frames. The undetermined amount of time may be an indication of a current configuration continuing until further notice or indefinitely.

The method can also include, at 520, communicating the way the subframe will be used to an affected device. The communicating can include, at 521, indicating that a current condition of the subframe will remain stable over the predetermined amount of time. The communicating can include, at 522, indicating that a current condition of the subframe will revert to previous condition within the predetermined amount of time.

The communicating can include, at 524, indicating a future condition for the subframe on a per subframe basis. For example, the communicating can include indicating a future condition for each subframe of a frame in each subframe of the frame.

For example, a frame may include a plurality of subframes. Each subframe of the plurality of subframes may include an indicator. Each indicator may indicate whether the entirety of the respective subframe that includes the indication will be designated for transmission in a first or a second direction in at least a future frame. The first and second directions may be uplink and downlink.

The communicating can include, at 526, indicating a base station's intentions in a flexible subframe by at least one of a presence/absence of a signal, combination of sequences, for example, similar to the ones used in primary synchronization sequence/secondary synchronization sequence, or explicitly encoding control bits into the TI signal. The communicating can include, at 527, transmitting a cell's intentions for a flexible subframe in an over-the-air manner before or during a first downlink transmission in a given subframe.

The method of FIG. 5 can be performed in one base station regarding the frame structure of another base station. As used herein the term “base station,” can broadly include an evolved Node B, an access point, or any other base station or wireless gateway. In certain embodiments, the “base station” can also refer to devices that include some functions of a base station, such as a wireless router or relay node.

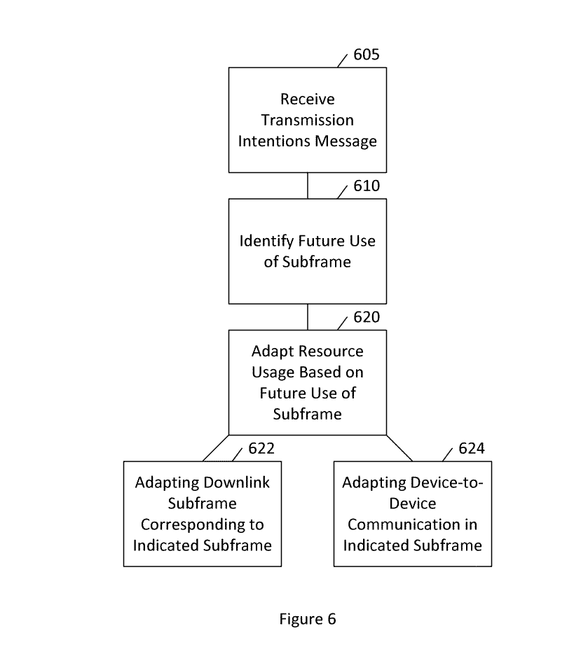

FIG. 6 illustrates another method according to certain embodiments. As shown in FIG. 6, a method can include, at 610, identifying a way in which a subframe in a frame structure will be used within a predetermined or undetermined amount of time. This identifying can be based on receiving, at 605, a transmission intentions message from a base station.

The method can also include, at 620, adapting a radio resource usage based on the way the frame structure will be used. The radio resource usage may be the frame structure of a victim base station, or some other characteristics, such as beam forming, transmission power, or modulation and coding scheme.

The adapting may include, at 622, adapting a downlink subframe corresponding to the subframe in which the frame structure will be used. The adapting may also or alternatively, at 624, adapting device-to-device communication in the subframe in which the frame structure will be used.

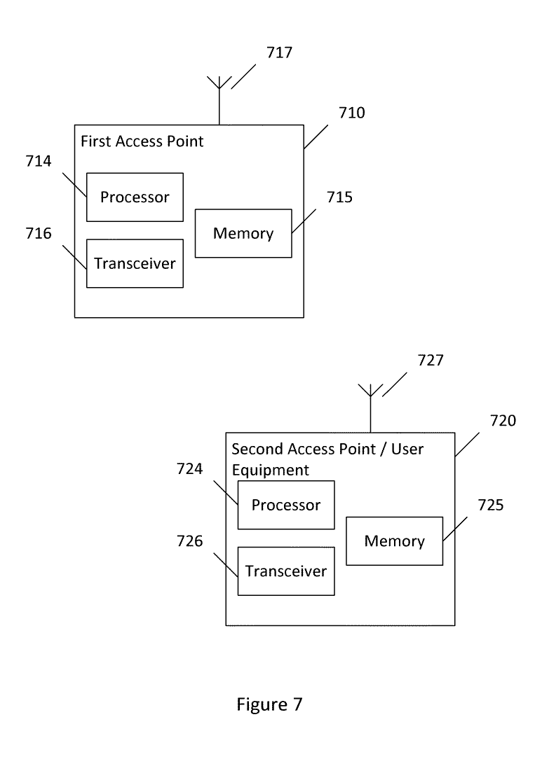

FIG. 7 illustrates a system according to certain embodiments of the invention. In one embodiment, a system may comprise several devices, such as, for example, first access point 710 and second access point 720. The system may comprise more than two access points, although only two are shown for the purposes of illustration. Each of these devices may comprise at least one processor, respectively indicated as 714 and 724. At least one memory may be provided in each device, and indicated as 715 and 725, respectively. The memory may comprise computer program instructions or computer code contained therein. One or more transceiver 716 and 726 may be provided, and each device may also comprise an antenna, respectively illustrated as 717 and 727. Although only one antenna each is shown, many antennas and multiple antenna elements may be provided to each of the devices. Other configurations of these devices, for example, may be provided. For example, first access point 710 and second access point 720 may be additionally configured for wired communication, in addition to wireless communication, and in such a case antennas 717 and 727 may illustrate any form of communication hardware, without being limited to merely an antenna.

Transceivers 716 and 726 may each, independently, be a transmitter, a receiver, or both a transmitter and a receiver, or a unit or device that may be configured both for transmission and reception.

Processors 714 and 724 may be embodied by any computational or data processing device, such as a central processing unit (CPU), application specific integrated circuit (ASIC), or comparable device. The processors may be implemented as a single controller, or a plurality of controllers or processors.

Memories 715 and 725 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate therefrom. Furthermore, the computer program instructions may be stored in the memory and which may be processed by the processors can be any suitable form of computer program code, for example, a compiled or interpreted computer program written in any suitable programming language.

The memory and the computer program instructions may be configured, with the processor for the particular device, to cause a hardware apparatus such as first access point 710 and second access point 720, to perform any of the processes described above (see, for example, FIGS. 4-6). Therefore, in certain embodiments, a non-transitory computer-readable medium may be encoded with computer instructions that, when executed in hardware, may perform a process such as one of the processes described herein. Alternatively, certain embodiments of the invention may be performed entirely in hardware.

Furthermore, although FIG. 7 illustrates a system including a first access point 710 and a second access point 720, embodiments of the invention may be applicable to other configurations, and configurations involving additional elements, as illustrated and discussed herein. For example, multiple user equipment devices and multiple access points may be present, or other nodes providing similar functionality, such as relays which may receive data from an access point and forward the data to a UE and may implement both functionality of a UE and functionality of the access point. Alternatively, the second access point 720 may instead be a user equipment, or may be a user equipment configured to serve as an access point for a small cell, such as a personal hotspot.

Certain embodiments may permit a victim cell a chance to react in view of aggressors cells' intentions in a flexible subframe of a following radio frame. The victim cell can thus adjust its transmission and prevent potential disturbance in connection.

In case of very detailed transmission intention (TI) messages, there may be control overhead. For example, a size of message may be comparable to a primary synchronization signal/secondary synchronization signal (PSS/SSS).

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

### GLOSSARY

BS base station

CRS common reference symbols

DL downlink

DTX discontinuous transmission

FBS femto base station

FUE femto user equipment (UE associated with FBS)

MCS modulation and coding scheme

NCT new carrier type

PDSCH physical downlink shared channel

PSS/SSS primary synchronization sequence/secondary synchronization sequence

PUCCH physical uplink control channel

PUSCH physical uplink shared channel

RACH random access channel

RS reference symbols

RSRP reference symbol received power

TDD time division duplex

TI message transmission intentions message

UE user equipment

UL uplink

1. A method, comprising:
determining a way in which a subframe in a frame structure will be used in the future; and
communicating an indication to an affected device in the subframe of a current frame indicating the way the subframe will be used in a following frame.

2. The method of claim 1, wherein the communicating comprises indicating that a current condition of the subframe will remain stable over a predetermined amount of time.

3. The method of claim 1, wherein the communicating comprises indicating that a current condition of the subframe will revert to previous condition within a predetermined amount of time.

4. The method of claim 1, wherein the communicating comprises indicating a future condition for the subframe on a per subframe basis.

5. The method of claim 1, wherein
a frame comprises a plurality of subframes,
each subframe of the plurality of subframes comprises an indicator,
each indicator indicating whether the entirety of the respective subframe comprising the indication will be designated for transmission in a first or a second direction in at least a future frame.

6. The method of claim 1, wherein the communicating comprises indicating a base station's intentions in a flexible subframe by at least one of a presence/absence of a signal combination of sequences, or explicitly encoding control bits into the signal.

7. The method of claim 1, wherein the communicating comprises transmitting a cell's intentions for a flexible subframe in an over-the-air manner before or during a first downlink transmission in a given subframe.

8. The method of claim 1, wherein, when it is determined that only a part of a flexible subframe bandwidth is to be used, the communicating includes providing a transmission intentions message within the subframe.

9. A method, comprising:
identifying a way in which a subframe in a frame structure will be used within a predetermined or undetermined amount of time; and
adapting a radio resource usage based on the way the frame structure will be used.

10. The method of claim 9, wherein the adapting comprises adapting a downlink subframe corresponding to the subframe.

11. The method of claim 9, wherein the adapting comprises adapting device-to-device communication.

12. An apparatus, comprising:
at least one processor;
at least one memory including computer program code,
wherein the at least one memory and the computer program code are configured to, with the at least one processor, cause the apparatus at least to
determine a way in which a subframe in a frame structure will be used in the future; and
communicate an indication to an affected device in the subframe of a current frame indicating the way the subframe will be used in a following frame.

13. The apparatus of claim 12, wherein the at least one memory and the computer program code are configured to, with the at least one processor, cause the apparatus at least to indicate that a current condition of the subframe will remain stable over a predetermined amount of time.

14. The apparatus of claim 12, wherein the at least one memory and the computer program code are configured to, with the at least one processor, cause the apparatus at least to indicate that a current condition of the subframe will revert to previous condition within a predetermined amount of time.

15. The apparatus of claim 12, wherein the at least one memory and the computer program code are configured to, with the at least one processor, cause the apparatus at least to indicate a future condition for each subframe of a frame in each subframe of the frame.

16. The apparatus of claim 12, wherein
a frame comprises a plurality of subframes,
each subframe of the plurality of subframes comprises an indicator,
each indicator indicating whether the entirety of the respective subframe comprising the indication will be designated for transmission in a first or a second direction in at least a future frame.

17. The apparatus of claim 12, wherein the at least one memory and the computer program code are configured to, with the at least one processor, cause the apparatus at least to indicate a base station's intentions in a flexible subframe by at least one of a presence/absence of a signal, combination of sequences, or explicitly encoding control bits into the signal.

18. An apparatus, comprising:
at least one processor;
at least one memory including computer program code,
wherein the at least one memory and the computer program code are configured to, with the at least one processor, cause the apparatus at least to
identify a way in which a subframe in a frame structure will be used in a following frame; and
adapt a radio resource usage based on the way the frame structure will be used.

19. The apparatus of claim 18, wherein the at least one memory and the computer program code are configured to, with the at least one processor, cause the apparatus at least to adapt a downlink subframe corresponding to the subframe.

20. The apparatus of claim 18, wherein the at least one memory and the computer program code are configured to, with the at least one processor, cause the apparatus at least to adapt device-to-device communication in the subframe.
